(19) United States
(12) Patent Application Publication
(10) Pub. No.: US 2009/0086774 A1
(43) Pub. Date: Apr. 2, 2009

(54) CONTROL DEVICE, LASER DEVICE, WAVELENGTH CONVERTING METHOD, AND PROGRAM

(76) Inventor: KOUICHI SUZUKI, Tokyo (JP)

Correspondence Address: NEC CORPORATION OF AMERICA, 6535 N. STATE HWY 161, IRVING, TX, 75039, US

(21) Appl. No.: 12/236,098

(22) Filed: Sep. 23, 2008

(30) Foreign Application Priority Data
Sep. 28, 2007 (JP) 2007-253941

(51) Int. Cl. H01S 3/10; G02F 1/35

(52) U.S. Cl. 372/20; 359/326

(57) ABSTRACT

A wavelength converting method of a wavelength tunable light source that is performing a phase modulation for a light output is disclosed. The wavelength converting method has an amplitude of a phase modulation have an amplitude value that is temporarily greater during a wavelength conversion than a phase modulation amount during non conversion. Therefore, an erroneous lock resulting from an abnormal oscillation wavelength can be prevented without spending the cost or time.

This application is based upon and claims the benefit of priority from Japanese paten application No. 2007-253941, filed on Sep. 28, 2007, the disclosure of which is incorporated herein in its entirety by reference.

### BACKGROUND OF THE INVENTION

1. Field of the Invention

The present invention relates to a wavelength converting operation of a wavelength tunable light source that is used in, for example, a wavelength division multiplexing (WDM) transmission system.

2. Description of Related Art

Due to the advent of a broadband age, in order to efficiently use an optical fiber, a WDM transmission system that enables a 1:N optical wavelength communication has been introduced. Recently, a dense wavelength division multiplexing (DWDM) device that multiplexes several tens of optical wavelengths to enable a faster transmission is being widespread. On this, each WDM transmission system needs a corresponding light source to each wavelength, and so its need is rapidly increasing due to high multiplexing.

Recently, a reconfigurable optical add/drop multiplexer (ROADM) that adds or drops a certain wavelength at each node is being studied for its commercialization. If the ROADM system is employed, in addition to an increment of the transmission capacity due to wavelength multiplexing, an optical path can be changed by changing a wavelength, so that a degree of freedom of an optical network can be rapidly raised.

As a light source of a WDM transmission system, a distributed feedback laser diode (DFB-LD) that performs single mode oscillation has been widely used due to convenience and high reliability. A DFB-LD includes a diffraction grating of about 30 nm depth formed in the whole oscillator area and obtains stable single mode oscillation with a wavelength corresponding to one obtained by multiplying a period of a diffraction grating and twice equivalent refractive index. In a DFB-LD that controls an oscillation wavelength by the operation temperature, however, since it is difficult to tune an oscillation wavelength in a broad range, a WDM transmission system is configured by using a product of which only wavelength is different for each ITU grid. For this reason, the shelf control cost is increased or surplus stock for coping with a malfunction is required. In a ROADM that changes an optical path by a wavelength, if a typical DFB-LD is used, a tunable width is restricted to a wavelength range of about 3 nm that can be changed by a temperature change. Therefore, there is a problem in that it is difficult to construct a flexible optical network by using a particular advantage of a ROADM that actively uses a wavelength resource.

In order to overcome the problem of a current DFB-LD and to realize a single mode oscillation in a wide wavelength range, researches on a wavelength tunable laser as a wavelength tunable light source are actively performed.

In a wavelength tunable laser, however, there is a problem in that the light output that is output during a wavelength conversion gets easily unstable. It is because an operation in an unstable operation condition is necessarily required while converting from a stable operation condition of one channel to a stable operation condition of the other channel. For this reason, there is a problem in that when or directly after a wavelength is converted, an abnormal state of an oscillation operation is easily caused.

The present invention relates to a technology that performs a control for continuously maintaining an optimum operation condition in order to stabilize an oscillation wavelength even during a wavelength conversion of a wavelength tunable light source.

For a passive lightwave circuit (PLC) type wavelength tunable light source like the present invention, technologies described in Japanese Patent Application Laid-Open (JP-A) Nos. 2006-196554 (Patent document 1) and 2006-216791 (Patent document 2) have been developed.

FIG. 1 is a schematic diagram illustrating a wavelength tunable light source.

A multiple resonator that realizes the laser is configured such that first to third resonators that have different optical path lengths from each other are connected by an optical coupling means. Here, an optical path length of the first resonator is L0, an optical path length of the second resonator is L1, and an optical path length of the third resonator is L2.

As each resonator, whatever functions as a resonator such as an etalon filter, a Mach-Zehnder interferometer, and a double refraction crystal as well as a ring resonator that will be described later can be used. The resonators that construct a multiple resonator are a little different in free spectral range (FSR) due to an optical path difference. For this reason, more light transmission occurs at a wavelength (resonant wavelength) with which a periodical change of light transmission occurring in each resonator agrees. As described above, in the present invention, resonators that are a little different in optical path length are serially connected to construct a multiple resonator, and the Vernier effect resulting therefrom is precisely used.

The first to third resonators may be first to third ring resonators that include ring-shaped waveguides with different optical path lengths, respectively. At this time, a wavelength tunable light source may construct a multiple resonator, an input/output side waveguide including one end connected to one of the first to third ring resonators through an optical coupling means, a reflection side waveguide including one end connected to another of the first to third ring resonators through an optical coupling means, a substrate on which the multiple resonator, the input/output side waveguide, and the reflection side waveguide are formed, a light reflector installed on the other end of the reflection side waveguide, a light amplifying means including a light input/output terminal connected to the other end of the input/output side waveguide through an anti-reflecting layer, and a wavelength tuning means for changing a resonant wavelength of a corresponding wavelength tunable light source by the multiple resonator.

Light emitted from the light amplifying means returns through a path that includes light input/output terminal→anti-reflecting layer→input/output side waveguide→multiple resonator→reflection side waveguide→light reflector→reflection side waveguide→multiple resonator→input/output side waveguide→anti-reflecting layer→light input/output terminal. The optical circuit functions as a filter, and only light of a certain wavelength returns. It is because the largest reflection occurs at a wavelength (resonant wavelength) with which a periodical change of a resonant frequency occurring in each ring resonator agrees.

Since the wavelength that agrees in the period is greatly changed by a combination of the circumference length of each ring resonator and a waveguide refractive index change, an efficient wavelength tuning operation is obtained. See JP-A No. 2006-196554 (Patent document 1). The waveguide refractive index can be changed by, for example, the thermo-optic effect. The thermo-optic effect is a phenomenon that a refractive index of a material is increased by heat, and is typically seen in any materials. That is, a resonant wavelength of the multiple resonator can be changed by using a temperature characteristic of a plurality of ring resonators. A wavelength can be also changed by a refractive index control method or a circumference length control method as well as the thermo-optic effect. For example, there is a method for controlling a resonant frequency or phase of each etalon by, for example, the temperature by combing Fabry-Perrot (FP) etalon filters in parallel.

As a wavelength tuning means, for example, one which heats a ring resonator like a film-like heater, one which cools down a ring resonator, one which changes a refractive index of an optical material, or one which mechanically changes the length of a waveguide can be used. As a light amplifying means, an optical amplifier such as a semiconductor optical amplifier (hereinafter, referred to as “SOA (semiconductor optical amplifier)”) that will be described later and an optical fiber amplifier or a light source such as a semiconductor laser (laser diode) can be used. A waveguide may be made of any material such as quartz glass or lithium niobate (LN).

In operating such a wavelength tunable light source, equipment for locking a wavelength is very important. The wavelength tunable light source can move an oscillation wavelength by about 5 THz in whole, but if a wavelength is set, it is required to continuously operate for about 20 years in a range of ±2.5 GHz. Wavelength precision for a tunable range has to be 1/1000 or more, and a refractive index of each component of the wavelength tunable light source has to continuously maintain four or more-digit precision. Meanwhile, it is very difficult to maintain four or more-digit optical refractive index stability for a long time by a device material that is actually used like a compound semiconductor. For this reason, a control for following a change of a refractive index to optimize an operating condition needs to be continuously performed.

In a ring resonator type wavelength tunable light source, in order to stabilize an oscillation wavelength, a dither control has been performed for a phase current of a SOA. FIG. 2 shows a phase current optimizing method.

As shown in FIG. 2, in a wavelength tunable light source, a control is performed for applying a phase current modulated to a sine wave of a frequency that is in a phase control area installed in a SOA and minimizing an alternating current (AC) amplitude of a PD current output that is output to a PD installed in a through port.

The phase control area can control a refractive index by a principle for changing a band gap of a compound semiconductor by an injection current of a light waveguide. In order to minimize the light output that is output to a through port, a- direct current (DC) component of a phase current is controlled, so that optimization to a stable laser operation condition is performed.

That is, when the AC amplitude which the light output oscillated from a laser is about a predetermined frequency change (100 MHz to 1 GHz) is performed in a phase control area of a SOA, a stably operating point is a condition that an AC component of a through PD output is a minimum. A DC value of a SOA phase current is continuously adjusted to be suitable for such an optimum operating point.

Such a control is called a phase current dither control, and a laser is operated for a long time under a stable operation condition by performing such an optimum control.

In a wavelength tunable light source using a tunable resonator like the present invention, when a laser is operated, due to deterioration of a SOA or a change of a refractive index of a PLC, a value of an optimum operating phase current gradually changes thereinside. One example of a phase characteristic when a characteristic deteriorates is shown in FIG. 2. If a SOA deteriorates, since a refractive index in a SOA delicately changes, an optimally operating SOA phase current value also changes as shown in FIG. 3. Therefore, since it depends on characteristic deterioration, a dither control is requisite.

As described above, since a follow-up to an optimum phase current value is performed by a dither control, there is no case where an oscillation wavelength is bounced even though a SOA or a PLC deteriorates due to the change of years.

Therefore, there does not occur a problem when a wavelength tunable light source continuously operates with the same wavelength, but when a wavelength channel is converted in the state that an operation is continuously performed during a time period when a wavelength tunable light source can deteriorate, if it is not corrected by a phase component deviated by the deterioration, a laser oscillation is performed under the condition of an unstable phase current.

In detail, an example that a dither lock is not properly operated is described with reference to FIG. 4. FIG. 4 is a graph plotting a transverse axis as the SOA phase current DC component amount and a vertical axis as the AC amplitude of a through PD.

An optimum control can be performed by adjusting a DC phase current value corresponding to a condition indicated by an arrow (proper wavelength lock).

However, as indicated by an arrow (abnormal lock), since a condition that a local minimum value represents a concave-type shape exists in a phase characteristic of the AC amplitude, there is a case where performed is optimization to a condition other than what is indicated by an arrow. That is, since a shape of a dither amplitude characteristic is not always an arranged shape, there is a possibility to judge that “lock” has been performed at an abnormal lock point, depending on an initial value when a wavelength is converted. Here, “lock” should be performed at a location “a”, but “lock” is performed at a location “b” or “c”.

If “lock” is performed under such a phase condition, an oscillation is performed at an undesired wavelength, or light of bad quality (the strength alternation occurs in a compound semiconductor due to nonlinear reduction) is output even though an oscillation is performed at a desired wavelength.

Next, a problem of the related art described above is described.

In a typical wavelength tunable light source, while converting a wavelength, a shutter is putted down to shield abnormal light from entering a fiber. During a typical operation, a shutter is in an open state. Therefore, it is not problematic if light of abnormal characteristic is output only while converting a wavelength.

In order to avoid the above problem, there is a method for installing an optic device that monitors a wavelength like a wavelength lock, but it increases the cost as much. There is also a method for measuring a phase characteristic by one time scanning to completely define a phase shape, but since in order to obtain an accurate phase characteristic shape, a measurement of high measuring precision needs to be performed, and a conversion takes a long time, it is not proper.

### SUMMARY

The present invention is to resolve the above-described problems. To this end, an exemplary object of the present invention is to provide a control device, a laser device, a wavelength converting method, and a program that can prevent an erroneous lock resulting from an abnormal oscillation wavelength without spending the cost or time.

### [Control Device]

In order to achieve the above object, a first aspect of the present invention provides a control device for controlling a wavelength conversion of a wavelength tunable light source that is performing a phase modulation for a light output including: a unit that has an amplitude of a phase modulation have an amplitude value that is temporarily greater during a wavelength conversion than a phase modulation amount during non conversion.

### [Laser Device]

A second aspect of the present invention provides a laser device, including: a control unit that controls a wavelength conversion of a wavelength tunable light source that is performing a phase modulation for a light output, the control unit including a unit that has an amplitude of a phase modulation have an amplitude value that is temporarily greater during a wavelength conversion than a phase modulation amount during non conversion.

### [Wavelength Converting Method]

A third aspect of the present invention provides a wavelength converting method of a wavelength tunable light source that is performing a phase modulation for a light output, including: having an amplitude of a phase modulation have an amplitude value that is temporarily greater during a wavelength conversion than a phase modulation amount during non conversion.

### [Program]

A fourth aspect of the present invention provides a computer-readable medium storing a program that allows a control device for controlling a wavelength conversion of a wavelength tunable light source that is performing a phase modulation for a light output to perform: a processing for having an amplitude of a phase modulation have an amplitude value that is temporarily greater during a wavelength conversion than a phase modulation amount during non conversion.

A fifth aspect of the present invention provides a computer-readable medium storing a program that allows a laser device for controlling a wavelength conversion of a wavelength tunable light source that is performing a phase modulation for a light source to perform a processing for having an amplitude of a phase modulation have an amplitude value that is temporarily greater during a wavelength conversion than a phase modulation amount during non conversion.

### BRIEF DESCRIPTION OF THE DRAWINGS

FIG. 1 is a configuration diagram illustrating a wavelength tunable light source according to a related art;

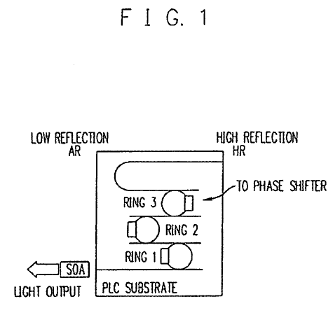

FIG. 2 is a view illustrating a structure of a dither lock according to the related art;

FIG. 3 is a view illustrating a phase characteristic when a characteristic deteriorates according to the related art;

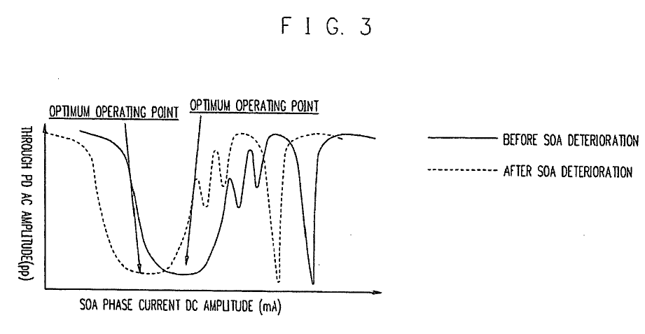

FIG. 4 is a view illustrating an example that a dither lock does not properly operate according to the related art;

FIG. 5 is a view illustrating a phase characteristic when the dither amplitude is increased according to an exemplary embodiment of the present invention;

FIG. 6 is a view illustrating dither amplitude increment according to the exemplary embodiment of the present invention;

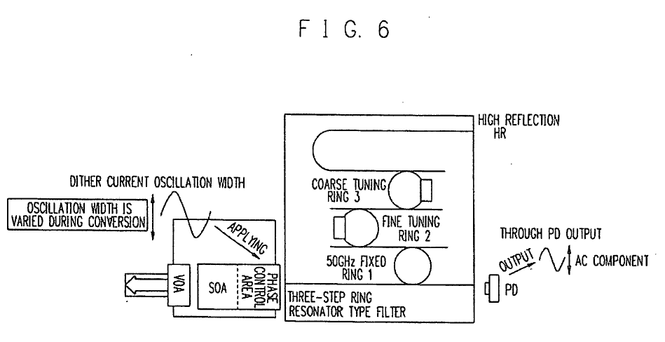

FIG. 7 is a view illustrating a processing flow of a wavelength conversion according to the exemplary embodiment of the present invention;

FIG. 8 is a view illustrating a processing flow of a wavelength conversion according to the exemplary embodiment of the present invention;

FIG. 9 is a view illustrating a processing flow of a wavelength conversion according to the exemplary embodiment of the present invention;

FIG. 10 is a view illustrating a processing flow of a wavelength conversion according to the exemplary embodiment of the present invention; and

FIG. 11 is a view illustrating a processing flow of a wavelength conversion according to the exemplary embodiment of the present invention.

### EXEMPLARY EMBODIMENT

Hereinafter, a wavelength converting method according to an exemplary embodiment of the present invention is described below in detail with reference to attached drawings.

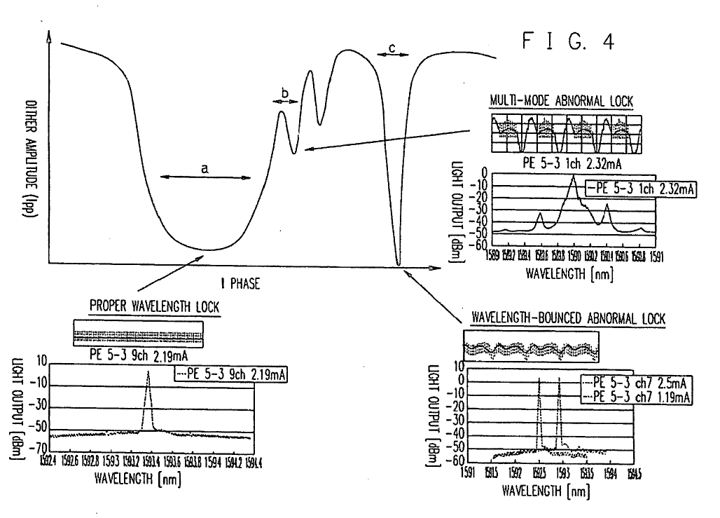

An optimum control can be performed by adjusting to a DC phase current value corresponding to a condition indicated by an arrow (proper wavelength lock) of FIG. 4, but as indicated by an arrow (abnormal lock), since a condition that a local minimum value represents a concave-type shape exists in a phase characteristic of the AC amplitude, there is a case where performed is optimization to a condition other than what is indicated by an arrow. Therefore, a study for preventing optimization to such a condition from being performed is required.

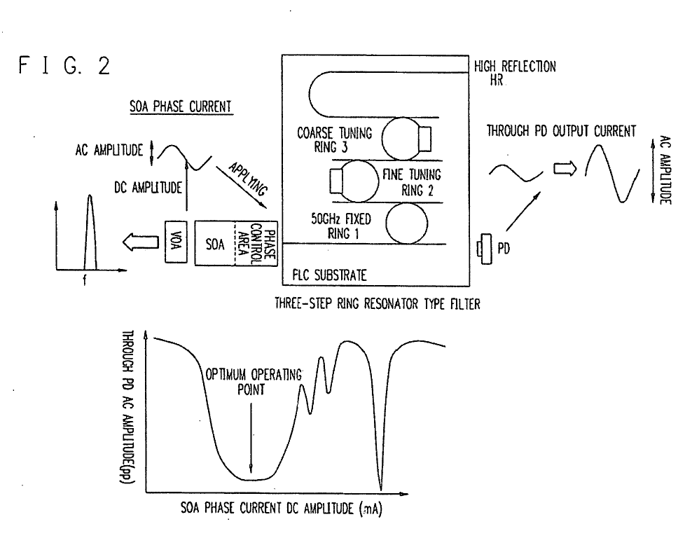

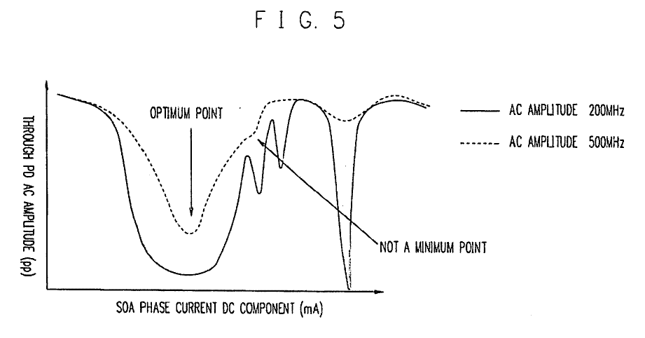

As shown in FIGS. 5 and 2, since a value of the AC amplitude is a difference between a maximum value and a minimum value of an oscillation width range, if the oscillation width of a dither amplitude is increased more than the oscillation width of a typical operation, there is an effect like averaging, so that a concave portion of a concave shaped ravine can be decreased.

Here, if the oscillation width of the phase amplitude during a wavelength conversion is oscillated greater than a set value during a typical operation, a wavelength lock in an abnormal phase condition is difficult to occur. By using the characteristic, an operation in an abnormal wavelength lock is controlled.

As shown in FIG. 5, a SOA phase amplitude is greatly enlarged, for example, to 500 MHz from 200 MHz. An AC component of a through PD is also increased in whole, and a minimum point that is not a normal operating point disappears. Therefore, there does not occur a case where an operation is performed at an abnormal lock point. In order to realize a stable phase lock operation, it is preferable to set to the relatively large SOA phase amplitude.

However, it is difficult to increase the phase amplitude of a SOA during a typical operation. It is because the phase amplitude of a SOA greatly affects quality of an oscillation wavelength. For example, if the phase amplitude is too small, for example, 100 MHz or less, nonlinear deterioration resulting from an optical nonlinear phenomenon called simulated Brillouin scattering occurs, and a signal wave form is greatly destroyed in an optical fiber, so that a transmission characteristic dramatically deteriorates. Also, if the phase amplitude is too large, for example, 500 MHz or more, a light output change called a remaining AM occurs in the light output due to an affection of a transmission characteristic shape of a PLC optical filter. If the light output change occurs, it greatly restricts the transmission distance. Since the phase amplitude determines a modulation value according to a specification of a transmitting device designed by a system vendor that uses a wavelength tunable light source, a wavelength tunable light source cannot be changed as it pleases.

Meanwhile, a problem of an abnormal output occurs when a wavelength is converted, in most cases, and it occurs because equipment for preventing light from leaking out like an optical shutter or a variable optical attenator (VOA) is installed in a wavelength tunable light source. Therefore, if the phase amplitude of a dither is increased only during a wavelength conversion, a stable wavelength conversion can be performed without deteriorating a light transmission characteristic. That is, a control method for shielding light by any method during a wavelength conversion, performing a wavelength conversion while performing a large phase modulation for the light output, and restoring the phase modulation amount to an original one when a conversion is completed is the present invention.

An optical shutter represents a device for converting ON/OFF, and a VOA represents a device for adjusting the light output. In case of a VOA, if an output is narrowed to the beginning, light is rarely output, and so it can be used as an optical shutter.

Next, a wavelength converting method according to the exemplary embodiment of the present invention that is controlled by a control means such as a CPU of a laser device equipped with a three-step ring resonator type filter is described below with reference to the attached drawings.

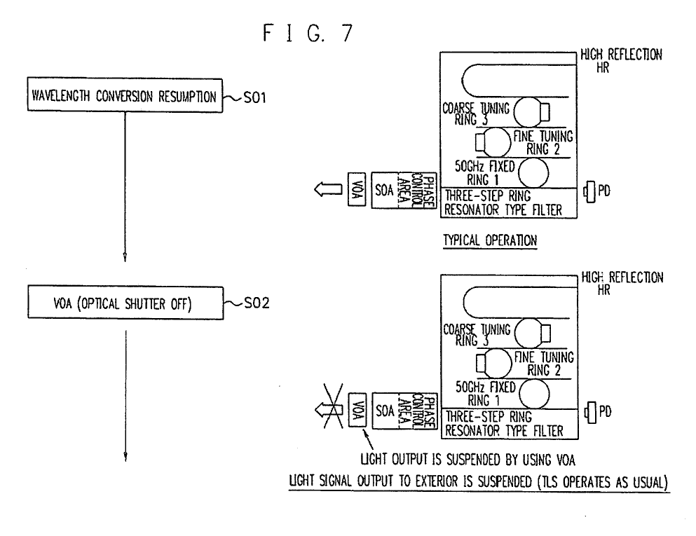

First, referring to FIG. 7, the three-step ring resonator type filer starts a wavelength conversion in a typical operation state (step So 1).

The light signal output to an exterior is suspended by a VOA (step S02). Since an operation is performed under an unstable phase condition while increasing the dither amplitude to perform an optimization adjustment, there is a high possibility that a wavelength other than a desired wavelength is output. That is, if the dither amplitude is increased, quality of output light also deteriorates. Therefore, in a state that the dither amplitude is increased, light should not be output, and a light shielding device like a VOA or an optical shutter needs to be installed to prevent light from leaking out from an MDL during a wavelength conversion. Using an optical shutter, it is possible to freely adjust increment or decrement of the dither amplitude. Here, a TLS operates as usual.

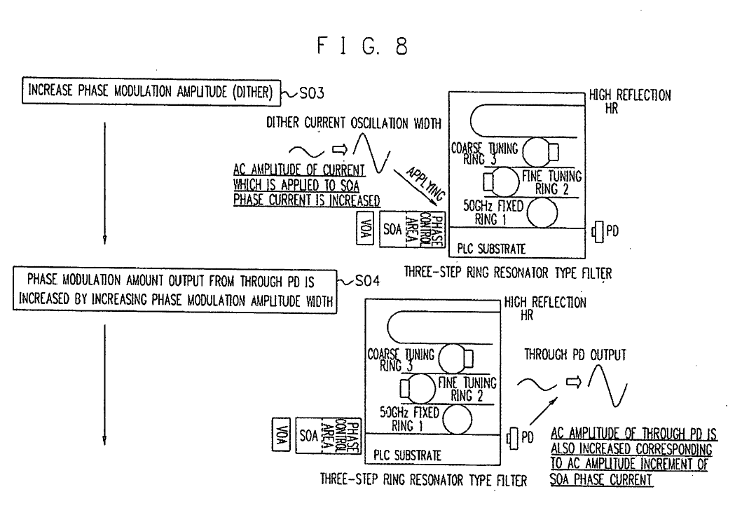

Subsequently, referring to FIG. 8, the phase modulation amplitude (dither) is increased (step S03). That is, the AC amplitude of an electric current that is being applied to a SOA phase current is increased.

The phase modulation amount output from a through PD is increased by increasing the phase modulation amplitude width (step S04). That is, the AC amplitude of a through PD is increased corresponding to the AC amplitude increment of a SOA phase current.

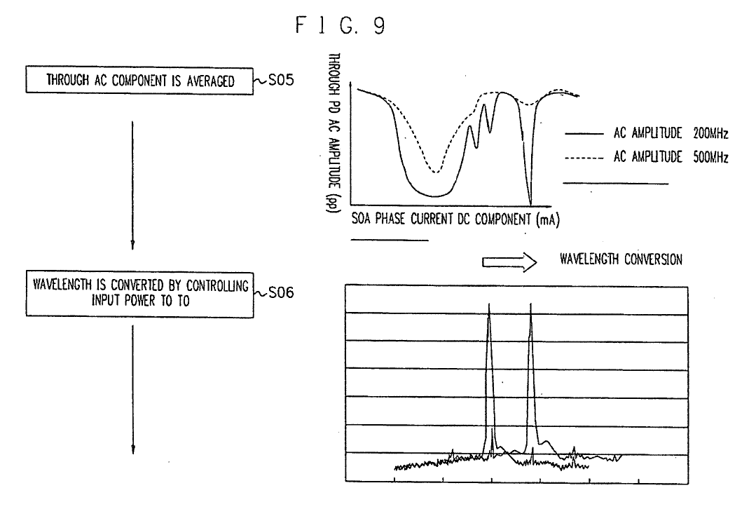

Referring to FIG. 9, a through AC component is averaged (step S05).

An input power to a TO is controlled to convert a wavelength (step S06).

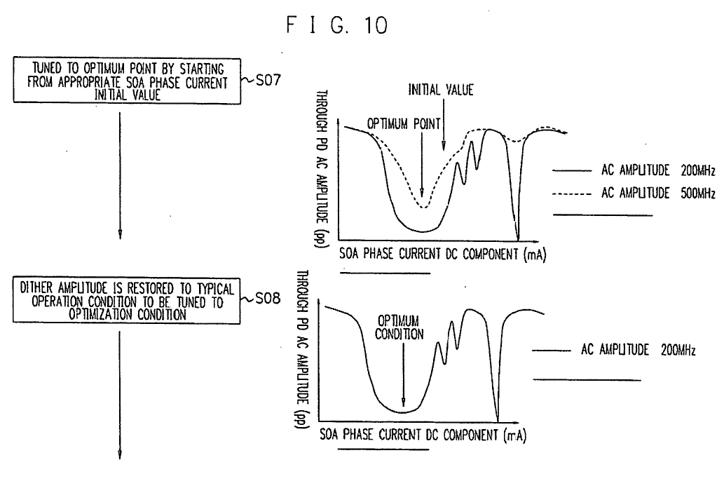

Referring to FIG. 10, tuning to an optimum value is performed by starting from an appropriate SOA phase current initial value (step S07).

The phase modulation amplitude (dither) is restored to a typical operation condition to tune to an optimization condition (step S08).

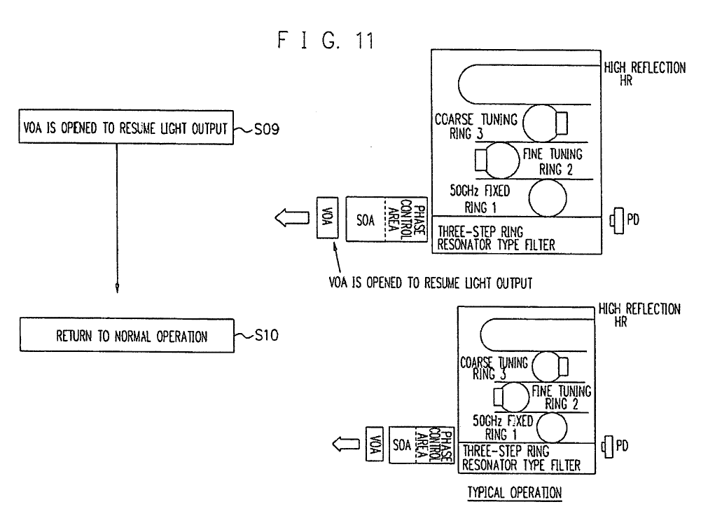

Referring to FIG. 11, a VOA is opened to resume the light output (step S09).

Thereafter, it returns to a normal operation (step S10).

A stable wavelength converting operation is achieved by controlling the dither amplitude while performing a wavelength converting operation of a wavelength tunable light source as described above.

The exemplary embodiment of the present invention can also be applied to a tunable light source using an etalon filter or a sample grating.

Each of the embodiments described above is a preferred embodiment of the present invention and can be variously modified without departing from the spirit of the present invention. For example, a process for achieving a function of a device may be performed by reading a program for achieving a function of a laser device into a device and performing it. Also, the program may be transmitted to other computer systems via a machine-readable recording medium like a CD-ROM or a magneto-optical disc or by a carrier wave via the Internet or a telephone line that is a transmission medium.

As one example of effects of the present invention, an erroneous lock resulting in an abnormal oscillation wavelength can be prevented without spending the cost or time.

What is claimed is:

1. A control device for controlling a wavelength conversion of a wavelength tunable light source that is performing a phase modulation for a light output, comprising:
a unit that has an amplitude of a phase modulation have an amplitude value that is temporarily greater during a wavelength conversion than a phase modulation amount during non conversion.

2. The control device of claim 1, wherein when the amplitude of the phase modulation has the amplitude value that is greater during the wavelength conversion than the phase modulation amount during non conversion, the light output is shielded by a device for controlling the light output such as an optical shutter.

3. A laser device comprising:
a control unit that controls a wavelength conversion of a wavelength tunable light source that is performing a phase modulation for a light output, the control unit comprising:
a unit that has an amplitude of a phase modulation have an amplitude value that is temporarily greater during a wavelength conversion than a phase modulation amount during non conversion.

4. The laser device of claim 3, wherein when the amplitude of the phase modulation has the amplitude value that is greater during the wavelength conversion than the phase modulation amount during non conversion, the control device shields the light output by an optical shutter.

5. A wavelength converting method of a wavelength tunable light source that is performing a phase modulation for a light output, comprising:
having an amplitude of a phase modulation have an amplitude value that is temporarily greater during a wavelength conversion than a phase modulation amount during non conversion.

6. The wavelength converting method of claim 5, wherein when the amplitude of the phase modulation has the amplitude value that is greater during the wavelength conversion than the phase modulation amount during non conversion, the light output is shielded by an optical shutter.

7. A computer-readable medium storing a program that allows a control device for controlling a wavelength conversion of a wavelength tunable light source that is performing a phase modulation for a light output to perform:
a processing of having an amplitude of a phase modulation have an amplitude value that is temporarily greater during a wavelength conversion than a phase modulation amount during non conversion.

8. The computer-readable medium storing the program of claim 7, wherein when the amplitude of the phase modulation has the amplitude value that is greater during the wavelength conversion than the phase modulation amount during non conversion, the light output is shielded by a device for controlling the light output such as an optical shutter.

9. A computer-readable medium storing a program that allows a laser device for controlling a wavelength conversion of a wavelength tunable light source that is performing a phase modulation for a light output to perform:
a processing of having an amplitude of a phase modulation have an amplitude value that is temporarily greater during a wavelength conversion than a phase modulation amount during non conversion.

10. The computer-readable medium storing the program of claim 9, wherein when the amplitude of the phase modulation has the amplitude value that is greater during the wavelength conversion than the phase modulation amount during non conversion, the light output is shielded by an optical shutter.

11. A control device for controlling a wavelength conversion of a wavelength tunable light source that is performing a phase modulation for a light output, comprising:
means for having an amplitude of a phase modulation have an amplitude value that is temporarily greater during a wavelength conversion than a phase modulation amount during non conversion.

12. A laser device comprising:
control means for controlling a wavelength conversion of a wavelength tunable light source that is performing a phase modulation for a light output, the control means comprising: means for having an amplitude of a phase modulation have an amplitude value that is temporarily greater during a wavelength conversion than a phase modulation amount during non conversion.
